(19) United States
(12) Patent Application Publication
(10) Pub. No.: US 2024/0200680 A1
(43) Pub. Date: Jun. 20, 2024

(54) FLUID VALVE WITH HALL SENSOR FOR EVAPORATIVE EMISSIONS SYSTEM

(71) Applicant: STONERIDGE, INC., NOVI, MI (US)

(72) Inventors: Benjamin Allen Harriger, Bellville, OH (US); Robert James Steinman, Lexington, OH (US); Gary Sorah, Lexington, OH (US); Trevor Adam Pryor, Mansfield, OH (US)

(21) Appl. No.: 18/287,097

(22) PCT Filed: May 3, 2022
(86) PCT No.: PCT/US2022/027400

§ 371 Date: Oct. 16, 2023

Related U.S. Application Data
(60) Provisional application No. 63/191,387, filed on May 21, 2021.

(51) Int. Cl. F16K 27/02; F02M 25/08

(52) U.S. Cl. CPC F16K 27/029; F02M 25/0818; F02M 25/0836; F02M 25/089; F02M 2025/0845

(57) ABSTRACT

A fluid valve includes a housing (70) that includes a first housing portion (76) that provides fluid passage that has an inlet port (72.74) and an outlet port (72, 74) that are configured to be in fluid communication with one another. The housing has a second housing portion (78) that is affixed to the first housing portion. The fluid valve further includes a solenoid (88) that is arranged within the first housing portion (76) and has a plunger (94) that is movable between open and closed positions to selectively fluidly connect the inlet and outlet ports. The fluid valve further includes a Hall effect sensor (102) that is arranged in the second housing portion (78) and is aligned with the plunger (94) in one of the opened and closed positions.

### CROSS-REFERENCE TO RELATED APPLICATION

This application claims priority to U.S. Provisional Application No. 63/191,387 filed May 21, 2021.

### TECHNICAL FIELD

This disclosure relates to a fluid valve having a position sensor for verifying an operating position of the valve. In one example, the disclosure relates to the valve arranged in an internal combustion engine evaporative emissions system and used for leak testing the system.

### BACKGROUND

Evaporative emissions systems have long been required for gasoline powered vehicles. The system must undergo a leak test during a vehicle start-up procedure to ensure that fuel vapors will not leak into the atmosphere. A pump is used either to create a vacuum or pressurize the system. An external filter is used to prevent contamination that could damage the pump or other components of the system during operation. Various valves may be closed during this test procedure to maintain system pressure, and the pressure is monitored to determine if there are any leaks.

In one typical system, a solenoid actuates a fluid valve in the system between open and closed positions during the test. While the fluid valve is quite durable and reliable over the life of the vehicle, it can be a failure point. A microswitch may be used within the valve housing to verify the valve position, but the switch is susceptible to failure due to contamination as it is difficult to seal from the flow path.

### SUMMARY

In one exemplary embodiment, a fluid valve includes a housing that includes a first housing portion that provides fluid passage that has an inlet port and an outlet port that are configured to be in fluid communication with one another. The housing has a second housing portion that is affixed to the first housing portion. The fluid valve further includes a solenoid that is arranged within the first housing portion and has a plunger that is movable between open and closed positions to selectively fluidly connect the inlet and outlet ports. The fluid valve further includes a Hall effect sensor that is arranged in the second housing portion and is aligned with the plunger in one of the opened and closed positions.

In a further embodiment of any of the above, the first housing portion is provided by first and second parts that are secured to one another about the solenoid. One of the inlet and outlet ports are arranged in one of the first and second parts, and the other of the inlet and outlet ports are arranged in the other of the first and second parts.

In a further embodiment of any of the above, the solenoid includes a stem that is disposed in a coil and joined to the plunger. The coil is mounted in the first part, and a seat is provided in the second part. The plunger abuts the seat in the closed position to fluidly block the inlet and outlet ports from one another.

In a further embodiment of any of the above, the Hall effect sensor is aligned with the plunger in the closed position.

In a further embodiment of any of the above, the first housing portion includes a first electrical connector that is in electrical communication with the solenoid. The second housing portion includes a second electrical connector that is discrete from the first electrical connector and is in electrical communication with the Hall effect sensor.

In a further embodiment of any of the above, the first and second housing portions are plastic and are provided between the Hall effect sensor and the plunger.

In a further embodiment of any of the above, the second housing portion at least partially circumscribes the fluid passage.

In a further embodiment of any of the above, the first and second housings include a locating feature to align the Hall effect sensor and the plunger in a desired relationship.

In a further embodiment of any of the above, the locating feature is provided by complementarily shaped walls that are provided by the first and second housings.

In a further embodiment of any of the above, the fluid valve includes a fastening element that secures the second housing to the first housings.

In another exemplary embodiment, an evaporative emissions system includes a fuel tank that is configured to contain fuel and fuel vapors, a charcoal canister that is configured to store the fuel vapors from the fuel tank, a fuel tank isolation valve that is fluidly provided between fuel tank and the charcoal canister, a purge valve that is in fluid communication with the charcoal canister and is configured to selectively provide the fuel vapors to an engine in response to a purge command. The system further includes a fluid valve fluid valve that includes a housing that includes a first housing portion that provides fluid passage that has an inlet port and an outlet port that are configured to be in fluid communication with one another. The housing has a second housing portion that is affixed to the first housing portion. The fluid valve further includes a solenoid that is arranged within the first housing portion and has a plunger that is movable between open and closed positions to selectively fluidly connect the inlet and outlet ports. The fluid valve further includes a Hall effect sensor that is arranged in the second housing portion and is aligned with the plunger in one of the opened and closed positions. The fluid valve further includes a controller that is in communication with the solenoid and the Hall effect sensor. The controller is configured to run a leak test procedure with the fluid valve.

In a further embodiment of any of the above, a leak detection module includes a canister valve solenoid, a pump, and a check valve. The leak detection module has a first fluid passageway that fluidly connects the canister valve solenoid to atmosphere. A second fluid passageway fluidly connects the charcoal canister to the pump through the check valve. The pump fluid is arranged between the check valve and atmosphere. The fluid valve provides at least one of the fuel tank isolation valve, the purge valve, the canister valve solenoid and the check valve.

In a further embodiment of any of the above, the first housing portion includes a first electrical connector that is in electrical communication with the solenoid, and the second housing portion includes a second electrical connector that is discrete from the first electrical connector and is in electrical communication with the Hall effect sensor. The controller is electrically connected to the first and second connectors.

In a further embodiment of any of the above, the controller is configured to command the solenoid to a desired position that includes one of an open position and a closed position, and includes an onboard diagnostic system that generates an engine malfunction code if the Hall sensor detects a position other than the desired position.

In another exemplary embodiment, a method of manufacturing a fluid valve includes the step of forming a fluid passage with a first housing portion. The first housing portion is arranged around a solenoid that has a plunger that is movable between open and closed positions to selectively fluidly connect inlet and outlet ports of the fluid passage. The method of manufacturing a fluid valve also includes the step of providing a second housing portion that has a Hall effect sensor to the first housing portion such that the Hall effect sensor is aligned with the plunger in one of the opened and closed positions.

In a further embodiment of any of the above, the providing step includes affixing the second housing portion to the first housing portion.

In a further embodiment of any of the above, the method includes the step of locating the second housing portion onto the first housing portion with complementarily shaped features.

In a further embodiment of any of the above, the affixing step includes fastening the second housing portion to the first housing portion.

In a further embodiment of any of the above, the fastening step includes permanently joining by at least one of gluing, bonding, and welding.

In a further embodiment of any of the above, the fastening step includes at least one of snap fitting and clipping.

In a further embodiment of any of the above, the forming step includes securing first and second parts of the first housing portion to one another and about the solenoid.

In a further embodiment of any of the above, the providing step includes over-molding the second housing portion onto the first housing portion.

### BRIEF DESCRIPTION OF THE DRAWINGS

The disclosure can be further understood by reference to the following detailed description when considered in connection with the accompanying drawings wherein:

FIG. 1 schematically illustrates portions of one example evaporative fuel system.

FIG. 2 is a schematic view of a leak detection module (LDM) for the system shown in FIG. 1.

FIG. 3 is a perspective view of an example fluid valve, which can be used in the system shown in FIG. 1.

FIG. 4 is a cross-sectional view of the fluid valve shown in FIG. 3 and taken along lines 4-4.

FIG. 5A is a perspective view of the second housing portion.

FIG. 5B is an end view of the second housing portion illustrated in FIG. 5A.

FIG. 5C is a cross-sectional view of the second housing portion taken along lines 5C-5C in FIG. 5B.

FIGS. 6A-6D are partial cross-sectional views illustrating various retaining element arrangements.

FIG. 7 is a flowchart depicting an example fluid valve manufacturing method.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

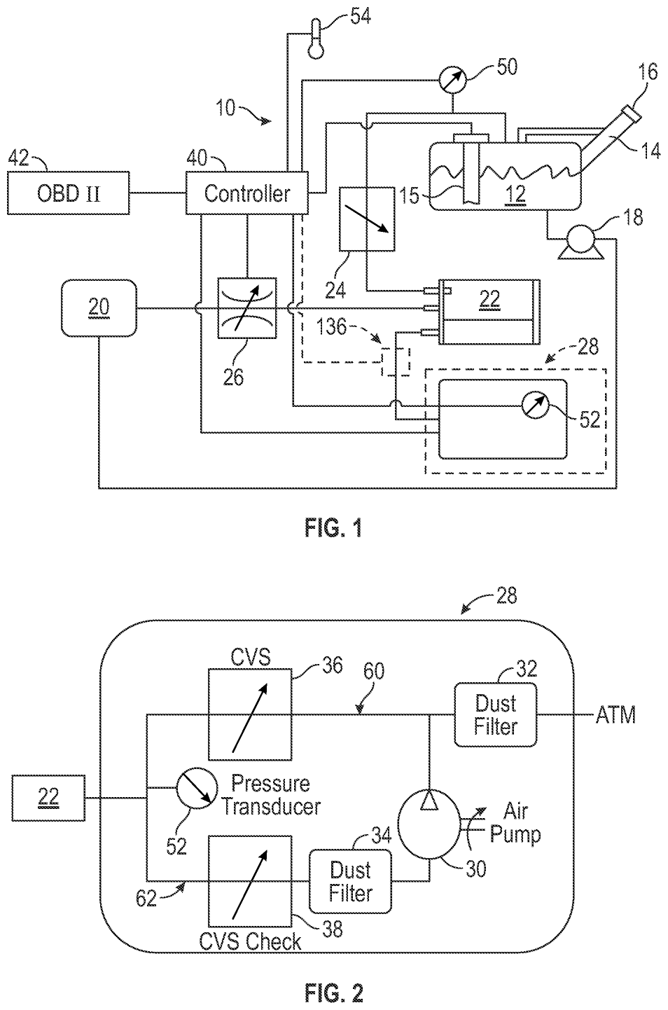

FIG. 1 schematically illustrates a portion of an example evaporative fuel system 10. It should be understood that other types of systems may be used. The system 10 includes a fuel tank 12 having a fuel filler 14 with a fill cap 16. A fuel pump 18 supplies gasoline, for example, from the fuel tank 12 to an internal combustion engine 20. A fuel level sensor 15 is in communication with a controller 40 and measures a level of fuel within the fuel tank 12, which also correlates to an amount of fuel vapor within the fuel tank 12.

The system 10 is configured to capture and regulate the flow of fuel vapors within the system. In one example, a fuel tank isolation valve (FTIV) 24 is arranged fluidly between the fuel tank 12 and a charcoal canister 22, which captures and stores fuel vapors for later use by the engine 20. A purge valve 26 is fluidly connected between the canister 22 and the engine 20. The controller 40 regulates a position of the purge valve 26 to selectively provide the fuel vapors to the engine 20 during operation to make use of these fuel vapors.

The integrity of the system 10 must be periodically tested to ensure no fuel vapors can leak from the system 10. One type of system 10 uses a leak detection module (LDM) 28, which can be used to pull a vacuum and/or pressurize the system to determine whether a leak exists, for example, using a pressure transducer 52. In one example leak test procedure, the purge valve 26 is closed and the controller 40 operates the leak detection module 28 to evacuate or pressurize the system. Another pressure transducer 50 may be used to monitor the pressure of fuel vapors within the fuel tank 12 during other conditions. An ambient temperature sensor 54 is in communication with the controller 40. The temperature sensor 54 may be useful for quantify heat transfer characteristics of the fuel vapor within the fuel tank 12 relative to surrounding atmospheric temperature.

The LDM is one optional system for leak detection where active leak testing is desired. Thus, the LDM 28 and its illustrated connections may be omitted. Other systems use ONLY the vacuum of the internal combustion engine for leak testing, such as a hybrid vehicle relying on “engine off natural vacuum” (EONV), which relies on the natural pressure/vacuum decay in the system for leak testing. For such systems, a canister valve solenoid (CVS) 136 would be used to selectively close off the charcoal canister 22 via control signal from the controller 40 (not shown) so that the pressure in the system can be monitored.

The LDM 28 is schematically shown in FIG. 2. The LDM 28 includes a pump 30 arranged in a housing. One example pump is disclosed in Provisional Application Ser. No. 62/910,708 filed on Oct. 4, 2019, entitled “PUMP FOR EVAPORATIVE EMISSIONS SYSTEM”, which is incorporated herein by referenced in its entirety. Some customers prefer a system that operates using a vacuum, while other customers prefer a system that is pressurized. So, to provide a pressurized evaporative emissions system test, the pump 30 will draw air from atmosphere through a filter 32 and direct the air towards the canister 22. Another filter 34 may be provided on the other side of the pump 30 to protect the pump from debris. To provide a depressurized or negative pressure evaporative emissions system test (i.e., vacuum), the pump 30 will draw air from the canister 22 and out to the atmosphere.

When the LDM 28 is not performing a leak check of the fuel system 10, a canister valve solenoid (CVS) 36 is in an open position to allow air to pass through a first fluid passageway 60 between the rest of the system 10 and atmosphere. This enables the system 10 to draw air from the atmosphere as needed.

When the LDM 28 is performing a leak test of the of the fuel system 10, the CVS 36 is in a closed position, which provides a second fluid passageway 62 on the side of the canister 22. A CVS check valve 38 is arranged in the second fluid passageway 62 and selectively blocks the canister 22 from the pump 30 and atmosphere. The pressure transducer 52 is arranged to read the pressure in the second fluid passageway 62 when the CVS 36 is closed, although the pressure transducer can be used for other purposes.

The LDM 28 contains the hardware necessary to determine if the system 10 has a leak to atmosphere. During a leak test, depending upon how the CVS check valve is configured the pump 30 can either create a negative pressure (vacuum) or a positive pressure in the evaporative emissions system as described above. The leak boundary of the system 10 includes the fuel filler 14 and cap 16, the purge valve 26, the fresh air side of the canister 22 (side connected to the LDM 28), the vapor dome of the fuel tank 12, and vapor lines connecting all components, including the second fluid passageway 62.

During the leak test, the pressure transducer 52 is in fluid communication with the second fluid passageway 62 and monitors the pressure condition generated by the pump 30 in the system 10. The pressure transducer 52 is in communication with the controller 40, which determines if there is a variation in pressure over a predetermined amount of time in the evaporative emissions system that might indicate a leak. Any change in pressure detected by the pressure transducer 52, which is monitored by the controller 40, is indicative of a leak. An OBDII diagnostics system 42 communicates with the controller 40 and uses the pressure information from the pressure transducer to generate engine malfunction codes that may be stored and for illuminating a “check engine” light on the vehicle instrument panel indicating vehicle service is needed.

The controller 40 and OBDII diagnostics system 42 may be integrated or separate. In terms of hardware architecture, such a controller can include a processor, memory, and one or more input and/or output (I/O) device interface(s) that are communicatively coupled via a local interface. The local interface can include, for example but not limited to, one or more buses and/or other wired (e.g., CAN, LIN and/or LAN) or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller may be a hardware device for executing software, particularly software stored in memory. The processor can be a custom made or commercially available processor, a central processing unit (CPU), an auxiliary processor among several processors associated with the controller, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, etc.). Moreover, the memory may incorporate electronic, magnetic, optical, and/or other types of storage media. The memory can also have a distributed architecture, where various components are situated remotely from one another, but can be accessed by the controller.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

When the controller is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

The above-described system 10, LDM 28 and method of operation are exemplary only. As can be appreciated, proper operation of the system 10 is highly dependent on desired operation of the various fluid valves (here, pneumatic), which must reliably open and close when commanded by the controller 40 to communicate and block flow when needed during both the evaporative emissions system test procedure and normal engine operation.

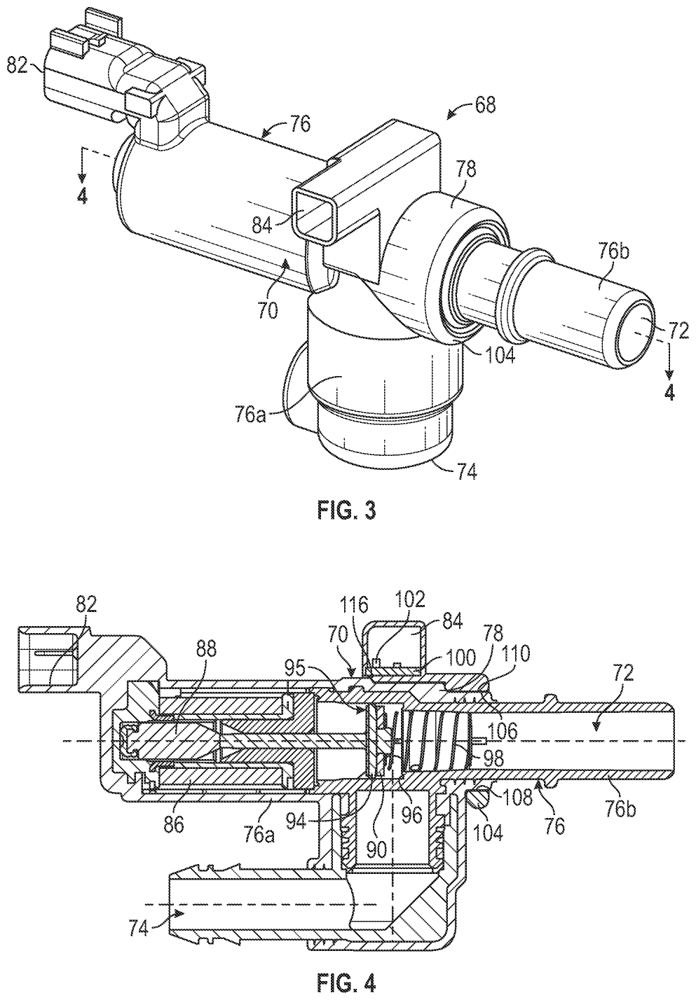

The disclosed fluid valve 68, shown in FIG. 3, is suitable for any one of the valves in the system 10, for example, the FTIV 24, the purge valve 26, the CVS 36, the CVS check valve 38, or any other valve within the system 10. In one example, the fluid valve 68 provides the FTIV 24, which is a valve for which position verification may be desired. Moreover, the disclosed fluid valve 68 may be used in other automotive systems or other applications.

As shown in FIGS. 3 and 4, the fluid valve 68 includes a housing 70 having a first housing portion 76 and a second housing portion 78 that is affixed to the first housing portion 76. In one example, the housing 70 is constructed from an automotive grade plastic, such as a nylon. The housing 70 provides a fluid passage, which may be defined entirely by the first housing portion 76, has first and second ports 72, 74. One of the first and second ports 72, 74 provides an inlet, and the other of the first and second ports 72, 74 provides an outlet. In the example, the first and second ports 72, 74 are arranged at an angle with respect to one another, e.g., 90°, which better enables a solenoid 88 to be packaged within the first housing portion 76.

In one example, the solenoid 88 has an armature 88 with a plunger 94 movable between open and closed positions to selective fluidly connect the first and second ports 72, 74. The plunger 94 can be ferrous to provide a target or non-ferrous, e.g., plastic, and a ferrous target 95 can be provided. In the example configuration, the armature 88 is disposed within a coil 86 arranged within a first part 76a of the first housing portion 76. A first electrical connector 82 is provided by the first housing portion 76 (first part 76a, for example) to electrically connect the solenoid 88 to, for example, the controller 40.

The first housing portion 76 includes a second parts 76b secured to the first part 76a and about the solenoid 88, for example, by overmolding, interference fit, welding and/or adhesive. One of the first and second ports 72, 74 is provided by the first part 76a, and the other of the first and second ports 72, 74 is provided by the second part 76b. In the example illustrated, the coil 86 is mounted in the first part 76a, and a seat 96 is provided by the second part 76b against which the plunger 94 engages in the closed position to fluidly block the first and second ports 72, 74 from one another. In the example, a spring 98 biases the plunger 94 to the normally open position, non-energized solenoid state. Energizing the coil 86 moves the plunger 94 from the open position to a closed position in in which a seal 90 abuts the seat 96.

The second housing portion 78 may be provided as an optional feature to the fluid valve 68 if position verification is desired. That is, the first housing portion 76 on its own provides a sealed leak path for fluid flow between the first and second ports 72, 74. A Hall sensor 102 can be arranged in the second housing portion 78 and aligned with the ferrous target (e.g., separate ferrous target 95 or ferrous plunger 94) in one of the open and closed positions (the open position in the illustrated example in FIG. 4) to detect the position of the plunger 94. A double-walled configuration is provided by the first housing in the region of the plunger 94 to provide a tight, secure fit between the first and second parts 76a, 76b. The Hall sensor 102 is mounted to a printed circuit board (PCB) 100 sealed within the second housing portion 78 and in electrical communication with a second electrical connector 84, which may also be connected to the controller 40. So, a third wall is arranged between the Hall sensor 102 and the plunger 94 since the second housing 78 is provided by a discrete stand-alone assembly.

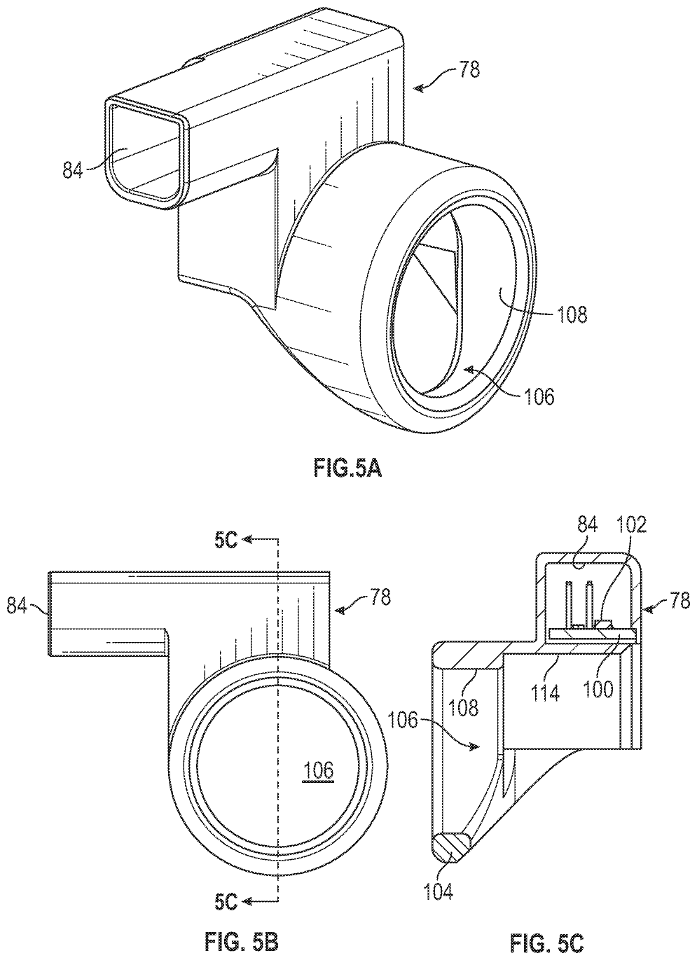

To facilitate ease of assembly while ensuring desired alignment between the Hall sensor 102 and the plunger 94, various locating features may be used. In an illustrated example shown in FIGS. 5A-5C, the second housing portion 78 includes a collar 104 providing an opening 106 such that the second housing portion 78 at least partially circumscribes the second part 76b of the first housing 76 and its fluid passage. That is, the inner diameter 108 of the opening 106 surrounds an outer diameter 110 of the first housing portion 76. The locating feature 112 is provided by a wall 114 of the collar 104 that abuts an edge 116 (FIG. 4) of the first housing portion 76. Due to the angle of the fluid passage, the collar 104 is “clocked” to a particular position relative to the first housing portion 76 when fully seated, arranging the first and second electrical connectors 82, 84 to repeatable relative positions.

The first and second housing portions 76, 78 could be constructed as a single unit, such that the first and second electrical connectors 82, 84 can be integrated with one another as a single connector. In one example, the second housing portion 78 is over-molded onto the first housing portion 76 to encapsulate the Hall sensor 102, which encapsulates the Hall sensor 102. Molding the fluid valve 68 in this manner may eliminate the need for bonding two discrete housings to one another.

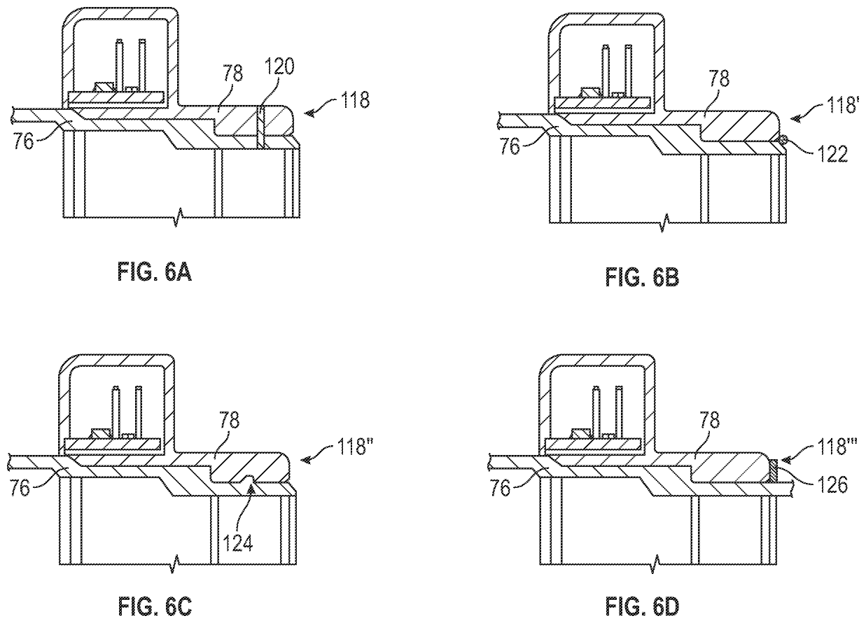

A retaining element 118-118″ is used to secure the second housing portion 78 relative to the first housing portion 76. Various examples are illustrated in FIGS. 6A-6B. In one example, a fastener 120, such as a pin, affixes the first and second housing portions 76, 78 to one another. In another example illustrated in FIG. 6B, a weld or adhesive 122 secures the first and second housing portions 76, 78 to one another. Other arrangements such as a snap fit 124 (FIG. 6C) or a clip 126 (FIG. 6D) may also be used.

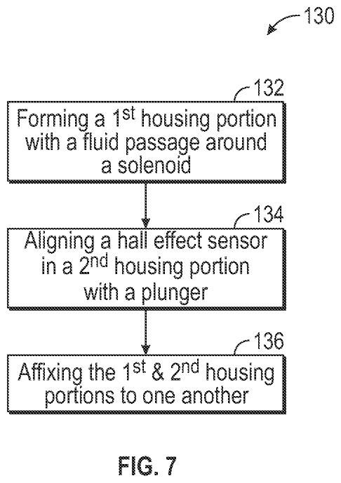

The fluid valve 68 is manufactured using a method 130 illustrated in FIG. 7. A first housing portion 76 with a fluid passage around a solenoid 88 is formed, as indicated at block 132. In one example, the first housing portion 76 is provided by first and second parts 76a, 76b, which may be overmolded or otherwise secured with respect to one another about the solenoid. A Hall effect sensor 102 is provided in a second housing portion 78 as an add-on module, and is aligned with respect to a plunger 94, as indicated at 134. In the example illustrated, the collar 104 of the second housing portion 78 is arranged over an end portion of the first housing portion 76. Due to the angle of the collar and the ninety-degree shape of the fluid passage, the second housing portion 78 may be easily circumferentially positioned and then seated with respect to the first housing portion 76. Referring to block 136, the second housing portion 78 is then affixed to the first housing portion 76 using, for example, a fastener, weld, adhesive, clip, and/or snap fit. In this manner, position verification may be easily provided to a simpler fluid valve as an add-on feature, if desired by the vehicle manufacturer.

The disclosed fluid valve can be used in a system 10 of the type described in this disclosure. In operation, the controller 40 is configured to command the solenoid 88 to a desired position including one of an open and closed position. The controller 40 includes an OBDII diagnostic system 42 that generates an engine malfunction code if the Hall effect sensor 102 detects a position other than the desired position. This communicates to the mechanic or operator that the fluid valve 68 is in need of replacement to restore desired operation of the system 10.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples. For example, the disclosed pump may be used in applications other than vehicle evaporative systems.

Although an example embodiment has been disclosed, a worker of ordinary skill in this art would recognize that certain modifications would come within the scope of the claims. For that reason, the following claims should be studied to determine their true scope and content.

What is claimed is:

1. A fluid valve comprising:
a housing including a first housing portion providing fluid passage having an inlet port and an outlet port configured to be in fluid communication with one another, the housing having a second housing portion affixed to the first housing portion;
a solenoid arranged within the first housing portion and having a plunger movable between open and closed positions to selectively fluidly connect the inlet and outlet ports; and
a Hall effect sensor arranged in the second housing portion and aligned with the plunger in one of the opened and closed positions.

2. The fluid valve of claim 1, wherein the first housing portion is provided by first and second parts secured to one another about the solenoid, wherein one of the inlet and outlet ports are arranged in one of the first and second parts, and the other of the inlet and outlet ports are arranged in the other of the first and second parts.

3. The fluid valve of claim 2, wherein the solenoid includes a stem disposed in a coil and joined to the plunger, the coil mounted in the first part, and a seat provided in the second part, the plunger abutting the seat in the closed position to fluidly block the inlet and outlet ports from one another.

4. The fluid valve of claim 3, wherein the Hall effect sensor is aligned with the plunger in the closed position.

5. The fluid valve of claim 1, wherein the first housing portion includes a first electrical connector in electrical communication with the solenoid, and the second housing portion includes a second electrical connector discrete from the first electrical connector and in electrical communication with the Hall effect sensor.

6. The fluid valve of claim 1, wherein the first and second housing portions are plastic and are provided between the Hall effect sensor and the plunger.

7. The fluid valve of claim 1, wherein the second housing portion at least partially circumscribes the fluid passage.

8. The fluid valve of claim 1, wherein the first and second housings include a locating feature to align the Hall effect sensor and the plunger in a desired relationship.

9. The fluid valve of claim 8, wherein the locating feature is provided by complementarily shaped walls provided by the first and second housings.

10. The fluid valve of claim 8, comprising a fastening element securing the second housing to the first housings.

11. An evaporative emissions system comprising:
a fuel tank configured to contain fuel and fuel vapors;
a charcoal canister configured to store the fuel vapors from the fuel tank;
a fuel tank isolation valve fluidly provided between fuel tank and the charcoal canister;
a purge valve in fluid communication with the charcoal canister and configured to selectively provide the fuel vapors to an engine in response to a purge command;
a fluid valve fluid valve including:
a housing including a first housing portion providing fluid passage having an inlet port and an outlet port configured to be in fluid communication with one another, the housing having a second housing portion affixed to the first housing portion;
a solenoid arranged within the first housing portion and having a plunger movable between open and closed positions to selectively fluidly connect the inlet and outlet ports; and
a Hall effect sensor arranged in the second housing portion and aligned with the plunger in one of the opened and closed positions; and
a controller in communication with the solenoid and the Hall effect sensor, the controller configured to run a leak test procedure with the fluid valve.

12. The system of claim 11, wherein a leak detection module including a canister valve solenoid, a pump, a check valve, the leak detection module having a first fluid passageway fluidly connecting the canister valve solenoid to atmosphere, a second fluid passageway fluidly connecting the charcoal canister to the pump through the check valve, the pump fluid arranged between the check valve and atmosphere, the fluid valve providing at least one of the fuel tank isolation valve, the purge valve, the canister valve solenoid and the check valve.

13. The system of claim 11, wherein the first housing portion includes a first electrical connector in electrical communication with the solenoid, and the second housing portion includes a second electrical connector discrete from the first electrical connector and in electrical communication with the Hall effect sensor, the controller electrically connected to the first and second connectors.

14. The system of claim 11, wherein the controller is configured to command the solenoid to a desired position including one of an open position and a closed position, and comprising an onboard diagnostic system that generates an engine malfunction code if the Hall sensor detects a position other than the desired position.

15. A method of manufacturing a fluid valve, comprising the steps of:
forming a fluid passage with a first housing portion, the first housing portion arranged around a solenoid having a plunger movable between open and closed positions to selectively fluidly connect inlet and outlet ports of the fluid passage; and
providing a second housing portion having a Hall effect sensor to the first housing portion such that the Hall effect sensor is aligned with the plunger in one of the opened and closed positions.

16. The method of claim 15, wherein the providing step includes affixing the second housing portion to the first housing portion.

17. The method of claim 16, comprising the step of locating the second housing portion onto the first housing portion with complementarily shaped features.

18. The method of claim 17, wherein the affixing step includes fastening the second housing portion to the first housing portion.

19. The method of claim 18, wherein the fastening step includes permanently joining by at least one of gluing, bonding, and welding.

20. The method of claim 18, wherein the fastening step includes at least one of snap fitting and clipping.

21. The method of claim 16, wherein the forming step includes securing first and second parts of the first housing portion to one another and about the solenoid.

22. The method of claim 15, wherein the providing step includes over-molding the second housing portion onto the first housing portion.
